(19) United States
(12) Patent Application Publication
(10) Pub. No.: US 2026/0228595 A1
(43) Pub. Date: Aug. 6, 2026

(54) QUANTUM COMPUTING APPARATUS, QUANTUM COMPUTING METHOD, AND PROGRAM

(71) Applicant: NTT, Inc., Tokyo (JP)

(72) Inventors: Suguru ENDO, Tokyo (JP); Yasunari SUZUKI, Tokyo (JP); Yuki TOKUNAGA, Tokyo (JP); Rui ASAOKA, Tokyo (JP); Kaoru YAMAMOTO, Tokyo (JP)

(21) Appl. No.: 19/147,041

(22) PCT Filed: Jan. 13, 2023
(86) PCT No.: PCT/JP2023/000855

§ 371 Date: Jul. 10, 2025

(51) Int. Cl. G06N 10/70; G06N 10/20; G06N 10/40; G06N 10/60

(52) U.S. Cl. CPC G06N 10/70; G06N 10/20; G06N 10/40; G06N 10/60

(57) ABSTRACT

A quantum computing device includes: a state creation unit that creates a non-physical state corresponding to a quantum state in which a projection operator to a code space of a rotation-symmetric bosonic code is applied to a quantum state in which an error has occurred during state preparation; and a quantum computing unit that executes a quantum algorithm using the non-physical state as an input and computes an expected value of an observable.

### TECHNICAL FIELD

The present invention relates to a technology for quantum error mitigation.

### BACKGROUND ART

As one of quantum error mitigation methods, there is a method called a symmetry expansion method (Non-Patent Literature 1 and 2). The symmetry expansion method is a method of mitigating an error by using symmetry in a case where a quantum system under consideration has the symmetry. This method is a method in which a projection operator to an ideal quantum state without a computational error is expanded by a symmetry operator, and a quantum state with a computational error is virtually changed to a quantum state without an error by post-processing of a computation result. As a result, the computational error is mitigated.

### CITATION LIST

### Non-Patent Literature

Non-Patent Literature 1: McClean, Jarrod R., Zhang Jiang, Nicholas C. Rubin, Ryan Babbush, and Hartmut Neven. “Decoding quantum errors with subspace expansions.” Nature communications 11, no. 1 (2020): 1-9.
Non-Patent Literature 2: Cai, Zhenyu. “Quantum error mitigation using symmetry expansion.” Quantum 5 (2021): 548.

### SUMMARY OF INVENTION

### Technical Problem

In the related art, the symmetry expansion method has been studied only in quantum computing using a two-level system (quantum bit), and cannot be directly adapted to continuous quantum computing using continuous observables such as light and microwave photons. In addition, the symmetry expansion method is a method of mitigating an error during computation by performing post-processing of a measurement result when performing measurement, which is the final step of quantum computing. However, in a case where an error in an input state (starting state) to a quantum circuit is very large, the error cannot be completely removed. In the continuous quantum computing, because a state preparation error in a starting state (which may be referred to as an initial state) is particularly large, this may become a serious problem.

Note that the problem that the state preparation error in the starting state is large is not limited to the continuous quantum computing, but also possibly may become a problem in, for example, quantum computing using the two-level system (quantum bit).

The present invention has been made in view of the above points, and an object of the present invention is to provide a technology that enables a state preparation error in a starting state in quantum computing to be mitigated.

### Solution to Problem

According to the disclosed technology, a quantum computing device is provided, the quantum computing device including:
a state creation unit that creates a non-physical state corresponding to a quantum state in which a projection operator to a code space of a rotation-symmetric bosonic code is applied to a quantum state in which an error has occurred during state preparation; and a quantum computing unit that executes a quantum algorithm using the non-physical state as an input and computes an expected value of an observable.

### Advantageous Effects of Invention

According to the disclosed technology, it is possible to mitigate a state preparation error in a starting state in quantum computing.

### BRIEF DESCRIPTION OF DRAWINGS

FIG. 1 is a diagram illustrating a configuration example of a quantum computing device 300.

FIG. 2 is a diagram illustrating a configuration example for realizing a bosonic quantum bit.

FIG. 3 is a diagram illustrating a functional configuration example of the quantum computing device 300.

FIG. 4 is a diagram illustrating an image of projection.

FIG. 5 is a diagram illustrating an image of error mitigation by a symmetry expansion method.

FIG. 6 is a flowchart for explaining the operation of the quantum computing device 300.

FIG. 7 is a diagram illustrating an example of a Hadamard test circuit.

FIG. 8 is a diagram illustrating an example of the quantum circuit.

FIG. 9 is a diagram illustrating an example of the quantum circuit.

FIG. 10 is a diagram illustrating an example of the quantum circuit.

FIG. 11 is a diagram illustrating a hardware configuration example of a control device 100.

### DESCRIPTION OF EMBODIMENTS

Hereinafter, one or more embodiments of the present invention (present embodiment) will be described with reference to the drawings. Each embodiment to be described below is merely an example, and the embodiments to which the present invention is applied are not limited to the following embodiments.

In the following description, Reference Literature is represented by numbers such as [3], and names of Reference Literature corresponding to the numbers are described at the end of the description. Note that Non-Patent Literature 1 and 2 described above corresponds to Reference Literature [1] and [2].

Furthermore, in the description of the following text, for convenience of description, a symbol (for example, \hat{ }) intended to be placed above a character (for example, ρ) is described before the character, such as “\hat{ }ρ”.

### (Overall Configuration Example of Device)

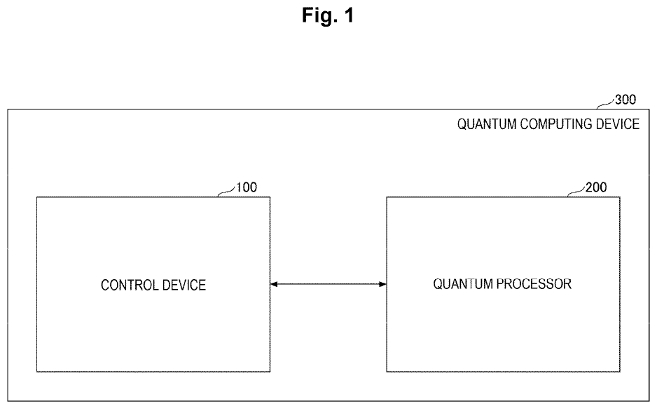

FIG. 1 illustrates a configuration example of a quantum computing device 300 according to the present embodiment. The “quantum computing device” may be referred to as a “quantum computer” or a “quantum computing system”.

As illustrated in FIG. 1, the quantum computing device 300 includes a control device 100 and a quantum processor 200. The control device 100 transmits a control signal or the like to the quantum processor 200 and acquires a computation result (measurement result) from the quantum processor 200 to perform quantum computing. The control device 100 can be implemented by, for example, a classical computer. Hereinafter, a “computer” means a “classical computer”.

The quantum processor 200 has a physical quantum system. In the present embodiment, a bosonic quantum bit that can perform continuous quantum computing is used as the quantum system, but the quantum system is not limited to using the above bit, and a quantum bit of a two-level system may be used.

As a physical system for realizing the quantum system, a microwave photon or the like for realizing the bosonic quantum bit is assumed, but the physical system is not limited thereto. For example, a superconducting circuit, an ion trap, a quantum dot, or the like may be used as the physical system.

### (Regarding Bosonic Quantum Bit)

Hereinafter, the bosonic quantum bit assumed to be used in the present embodiment will be described.

The bosonic quantum bit is represented by, for example, a photon number state (which may be referred to as a Fock state) of microwave photons in a three-dimensional cavity. That is, the states of the bosonic quantum bit can be represented by the superposition of |0 [symbol] , |1 [symbol] , |2 [symbol] , . . . , |n [symbol] corresponding to the states with 0, 1, 2, . . . , n microwave photons in the cavity.

The manipulation of the photon number state in the bosonic quantum bit is performed, for example, by allowing the cavity to interact with a superconducting quantum bit (for example, a transmon). This superconducting quantum bit is called an ancillary quantum bit (auxiliary quantum bit).

As a method of encoding the bosonic quantum bit, for example, there is a method of using |0 [symbol] _{L}=(1/√2)(|0)+|4 [symbol] ) and |1)_{L}=|2 [symbol] , in which the average number of photons is equal and even, as two states (a logic 0 state and a logic 1 state).

The main error that occurs in the cavity is a decrease in the number of photons. For the bosonic quantum bit, it is possible to measure parity of the number of photons without breaking the quantum state. For example, in a case where an odd number is observed, it is determined that a photon loss has occurred, and an error can be corrected by adding photons.

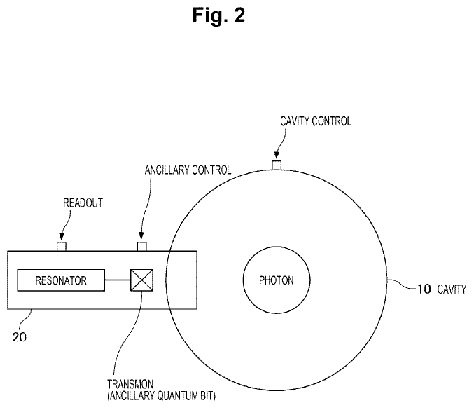

FIG. 2 illustrates a configuration example for realizing the bosonic quantum bit in the case of using the cavity. For example, a plurality of configurations illustrated in FIG. 2 is disposed in the quantum processor 200 illustrated in FIG. 1.

As illustrated in FIG. 2, the present configuration includes a unit 20 including a readout resonator and a transmon, and a cavity 10 that confines photons. The photon confined in the cavity 10 realizes a bosonic quantum bit.

Hereinafter, unless otherwise specified, the “quantum state” is a quantum state of the bosonic quantum bit. Note that, in the present description and the claims, a quantum system that can perform continuous quantum computing may be referred to as a “quantum bit” similarly to a two-level system, or a quantum system that can perform continuous quantum computing may be referred to as a “quantum mode”.

### (Functional Configuration Example of Quantum Computing Device 300)

“The control device 100 and the quantum processor 200” included in the quantum computing device 300 cooperate to implement a function of quantum computing by the quantum computing device 300.

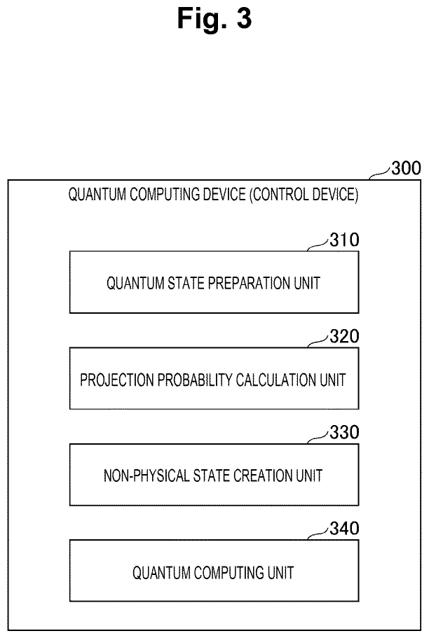

FIG. 3 illustrates a functional configuration example of the quantum computing device 300 of the present embodiment. As illustrated in FIG. 3, the quantum computing device 300 includes a quantum state preparation unit 310, a projection probability calculation unit 320, a non-physical state creation unit 330, and a quantum computing unit 340. The operation of each unit will be described later. Because the subject of control for quantum computing is in the control device 100, the functional configuration illustrated in FIG. 3 may be regarded as the functional configuration of the control device 100.

Note that the non-physical state creation unit 330 may be referred to as a state creation unit. In addition, “the quantum state preparation unit 310, the projection probability calculation unit 320, the non-physical state creation unit 330, and the quantum computing unit 340” in the quantum computing device 300 do not need to be provided in one device. For example, “the non-physical state creation unit 330 and the quantum computing unit 340” may be present in one device, and the quantum state preparation unit 310 and the projection probability calculation unit 320 may be present in one or more devices at different locations.

Furthermore, the bosonic quantum bit in the present embodiment is not limited to one using an actual physical system. For example, the bosonic quantum bit may be on a simulator realized by software. In this case, the quantum processor 200 functions as a simulator of the bosonic quantum bit. This simulator may be provided inside the control device 100.

### (Technique Used in the Present Embodiment)

In the present embodiment, the quantum computing device 300 uses rotation symmetry of an error correction code called a rotation-symmetric bosonic code [3] in order to enable the symmetry expansion method to be applied even in the continuous quantum computing. In addition, the quantum computing device 300 uses the generalization process proposed in Reference Literature [4] in order to mitigate the state preparation error of the starting state (initial state) in the quantum computing.

First, an outline of the rotation-symmetric bosonic code and the symmetry expansion method will be described.

### <Rotation-Symmetric Bosonic Code>

The outline of the rotation-symmetric bosonic code (RSBC) used in the present embodiment will be described.

A logic state of the M-th order rotation-symmetric bosonic code is expressed by the following expression.

$$[ Math . 1 ]$$

$$\vert {0}_{M , Φ} \text{?} = {𝒞}_{0}^{- 1 / 2} {{\sum }_{k = 0}}^{2 M - 1} exp ( i \frac{k π}{M} \hat{N} ) \vert Φ \text{?}$$

$$\vert {1}_{M , Φ} \text{?} = {𝒞}_{1}^{- 1 / 2} {{\sum }_{k = 0}}^{2 M - 1} {( - 1 )}^{k} exp ( i \frac{k π}{M} \hat{N} ) \vert Φ \text{?}$$

In the above expression, |Φ [symbol] is an appropriately selected primitive state. C₀ and C₁ are normalized constants, respectively, and asymptotically approach 2M as the number of photons increases. \hat{ }N=\hat{ }a^{†}\hat{ }a is a number operator, and \hat{ }a and \hat{ }at are an annihilation operator and a creation operator, respectively.

The above two logic states are stabilized by a rotation operator \hat{ }R_{M}=exp(i(2π/M)\hat{ }N). \hat{ }Z_{M}=\hat{ }R_{2M}=exp(i(n/M)\hat{ }N) functions as a logical Z operator. Further, in the Fock basis, two logical states are expressed as follows.

$$[ Math . 2 ]$$

$$\vert {0}_{M , Φ} \text{?} = {{\sum }_{n = 0}}^{∞} {c}_{2 n M}^{( Φ )} \vert 2 n M \text{?}$$

$$\vert {1}_{M , Φ} \text{?} = {{\sum }_{n = 0}}^{∞} {c}_{( 2 n + 1 ) M}^{( Φ )} \vert ( 2 n + 1 ) M \text{?}$$

In the above expression, c^{(Φ)}ᵢ is a probability amplitude depending on the primitive state |Φ [symbol] . In addition, the state |±_{M,Φ} [symbol] =1/√2 (|0_{M,Φ} [symbol] ±|1_{M,Φ} [symbol] ) is expressed by the following.

$$[ Math . 3 ]$$

$$\vert {+}_{M , Φ} \text{?} = \frac{1}{\sqrt{2}} {{\sum }_{n = 0}}^{∞} {c}_{n M}^{( Φ )} \vert n M \text{?}$$

$$\vert {-}_{M , Φ} \text{?} = \frac{1}{\sqrt{2}} {{\sum }_{n = 0}}^{∞} {( - 1 )}^{n} {c}_{n M}^{( Φ )} \vert n M \text{?}$$

### <Regarding Symmetry Expansion Method>

An outline of a symmetry expansion method (SE) used in the present embodiment will be described. By the symmetry expansion method, a noisy quantum state can be virtually projected into a symmetric subspace.

Defining a finite group of symmetry operators as S, a state |ψ_{S} [symbol] of the symmetric subspace can be stabilized as follows.

$$[ Math . 4 ]$$

$$\hat{𝒮} \vert {ψ}_{𝕊} \text{?} = \vert {ψ}_{𝕊} \text{?} ∀ \hat{𝒮} ∈ 𝕊$$

The projection operator to the symmetric subspace is expressed by the following.

$$[ Math . 5 ]$$

$${\hat{𝒫}}_{𝕊} = \frac{1}{\vert 𝕊 \vert} {\sum }_{\hat{𝒮} ∈ 𝕊} \hat{𝒮}$$

The noisy state \hat{ }ρ is projected into the symmetric subspace as follows.

$$[ Math . 6 ]$$

$${\hat{ρ}}_{𝕊} = \frac{{\hat{𝒫}}_{𝕊} \hat{ρ} {\hat{𝒫}}_{𝕊}}{Tr [ {\hat{𝒫}}_{𝕊} \hat{ρ} ]}$$

In addition, in the symmetry expansion method, an error in an expected value of an observable can be mitigated by post-processing of a measurement result. The measured observable is defined as \hat{ }O. It is assumed that \hat{ }O is commuted with a projection operator \hat{ }P_{S}. The expected value in which the error is mitigated is expressed by the following expression.

$$[ Math . 7 ]$$

$$\text{?} Ô {\text{?}}_{𝕊} = \frac{1}{{p}_{𝕊} \vert 𝕊 \vert} {\sum }_{\hat{𝒮} ∈ 𝕊} Tr [ \hat{𝒮} \hat{𝒪} \hat{ρ} ]$$

$${p}_{𝕊} = \frac{1}{\vert 𝕊 \vert} {\sum }_{\hat{𝒮} ∈ 𝕊} Tr [ \hat{𝒮} \hat{ρ} ]$$

### (Outline of Operation of Quantum Computing Device 300)

The quantum computing device 300 according to the present embodiment causes the projection operator \hat{ }P_{S} to the code space of the rotation-symmetric bosonic code to be applied to the quantum state \hat{ }ρ in which an error has occurred during state preparation in the starting state, and “virtually” obtains an error-mitigated quantum state \hat{ }ρ_{SE} expressed by the following Expressions (1) to (3).

Here, “virtually” means that when the quantum algorithm is executed and an expected value of a certain observable is obtained, the same expected value as in a case where the density operator \hat{ }ρ_{SE} can be prepared as the input state (starting state) can be obtained as the expected value, and it does not mean that the quantum state \hat{ }ρ_{SE} can be directly prepared.

$$[ Math . 8 ]$$

$${\hat{ρ}}_{SE} = \frac{1}{{p}_{𝕊}} {\hat{𝒫}}_{𝕊} \hat{ρ} {\hat{𝒫}}_{𝕊} = \frac{1}{{p}_{𝕊} {\vert 𝕊 \vert}^{2}} {\sum }_{\hat{𝒮} , {\hat{𝒮}}^{′} ∈ 𝕊} \hat{𝒮} \hat{ρ} {\hat{𝒮}}^{′} \qquad ( 1 )$$

$$[ Math . 9 ]$$

$${\hat{𝒫}}_{𝕊} = \frac{1}{\vert 𝕊 \vert} {\sum }_{\hat{𝒮} ∈ 𝕊} \hat{𝒮} \qquad ( 2 )$$

$$[ Math . 10 ]$$

$${p}_{𝕊} = Tr [ {\hat{𝒫}}_{𝕊} \hat{ρ} ] \qquad ( 3 )$$

In the present embodiment, because the rotation-symmetric bosonic code is used, S in the present embodiment is a set of rotation operators, and |S| is the number of elements thereof. p_{S} is a projection probability to the code space. More specifically, a case where the quantum state \hat{ }ρ in which the error is to be mitigated is the logic 0 state is expressed by the following.

$$[ Math . 11 ]$$

$${\hat{𝒫}}_{𝕊} = \frac{1}{2 M} {\sum }_{k = 0}^{2 M - 1} {e}^{i \frac{π}{M} k \hat{N}}$$

$$( \hat{𝒮} = {e}^{i \frac{π}{M} k \hat{N}} ( k = 0 , 1 , … , 2 M - 1 ) )$$

A case where the general superposition state of the logic 0 and the logic 1 is expressed by the following.

$$[ Math . 12 ]$$

$${\hat{𝒫}}_{𝕊} = \frac{1}{M} {\sum }_{k = 0}^{M - 1} {e}^{i \frac{2 π}{M} k \hat{N}}$$

$$( \hat{𝒮} = {e}^{i \frac{2 π}{M} k \hat{N}} ( k = 0 , 1 , … , M - 1 ) )$$

Here, M is the number of rotation symmetry operators of the code space of the rotation-symmetric bosonic code, and \hat{ }N is a particle number operator.

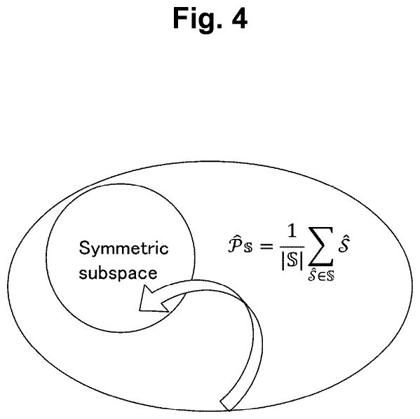

FIG. 4 illustrates an image in which a noisy state is projected to a symmetric subspace by using the projection operator \hat{ }P_{S}. As shown in Expression (2), the projection operator \hat{ }P_{S} is expanded by using \hat{ }S. Note that this symmetric subspace corresponds to the above-described “code space of the rotation-symmetric bosonic code”.

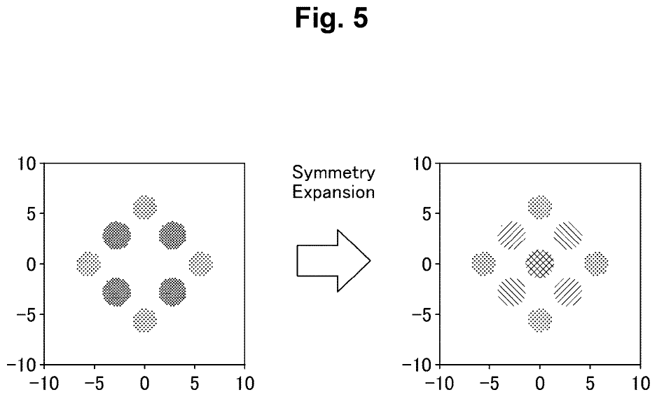

FIG. 5 illustrates an image of error mitigation by the symmetry expansion method. The left side of FIG. 5 illustrates a distribution of the Wigner function for the logic 0 state with photon loss noise (error) in a case where the rotation order is M=2. The right side of FIG. 5 illustrates a distribution of the Wigner function for the logic 0 state in which the error is mitigated by the symmetry expansion method. As illustrated in FIG. 5, it can be seen that interference fringes are restored by the error mitigation using the symmetry expansion method.

### (Operation Flow of Quantum Computing Device 300)

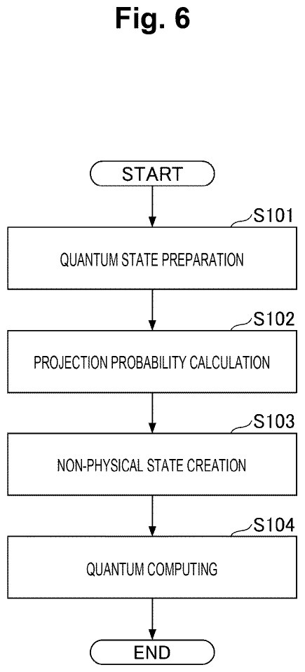

Next, an operation example of the quantum computing device 300 having the functional configuration of FIG. 3 will be described along the procedure of the flowchart in FIG. 6. This operation example is an operation example for preparing a starting state in which an error is mitigated.

### <S101: Quantum State Preparation>

In S101, the quantum state preparation unit 310 prepares N quantum states \hat{ }ρᵢ (i=1, 2, . . . . N) to be input to a quantum circuit. In general, \hat{ }pᵢ is a state in which an error such as a photon loss has occurred. To prepare the quantum state \hat{ }ρᵢ means, for example, to set the bosonic quantum bit to a certain quantum state \hat{ }ρᵢ by the control on the quantum processor 200 by the control device 100.

### <S102: Projection Probability Calculation>

In S102, the projection probability calculation unit 320 obtains a projection probability p_{S}⁽ⁱ⁾. In a case where a noise model of the state preparation is known, the projection probability p_{S}⁽ⁱ⁾ of Expression (3) can be obtained by simulation by the control device 100 (classical computer). In a case where the noise model is unknown, the projection probability calculation unit 320 may compute the projection probability p_{S}⁽ⁱ⁾ by using a Hadamard test circuit.

For example, in a case where the symmetry expansion method is used for the logic 0 state, the following is obtained.

$$[ Math . 13 ]$$

$${p}_{𝕊}^{( i )} = \frac{1}{2 M} {\sum }_{k = 0}^{2 M - 1} Tr [ {e}^{i \frac{π}{M} k \hat{N}} {\hat{ρ}}_{i} ]$$

For the following portion in the above expression, an ancillary quantum bit (state|+ [symbol] ₀) is prepared, and the computation using the Hadamard test circuit is performed.

$$[ Math . 14 ]$$

$$Tr [ {e}^{i \frac{π}{M} k \hat{N}} {\hat{ρ}}_{i} ]$$

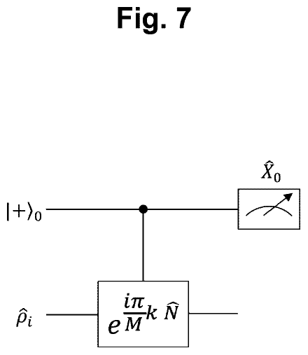

As a result, the projection probability p_{S}⁽ⁱ⁾ can be calculated. FIG. 7 illustrates an example of the Hadamard test circuit. Note that, at the time of computing linear combination, only the expected value of Pauli X may be computed because the imaginary part is 0.

### <S103: Non-Physical State Creation>

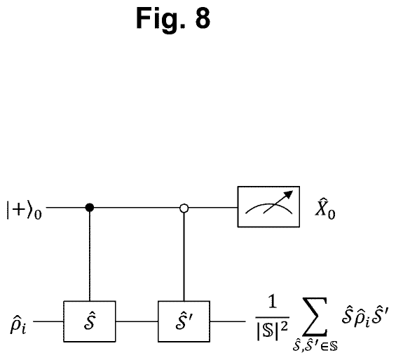

In S103, the non-physical state creation unit 330 uses the quantum circuit illustrated in FIG. 8 to virtually create the following non-physical state.

$$\frac{1}{{\vert 𝕊 \vert}^{2}} {\sum }_{\hat{𝒮} , {\hat{𝒮}}^{′} ∈ 𝕊} \hat{𝒮} {\hat{ρ}}_{i} {\hat{𝒮}}^{′} ( i = 1 , 2 , … , N ) \qquad [ Math . 15 ]$$

This virtual non-physical state is proportional to the quantum state \hat{ }ρ_{SE}⁽ⁱ⁾ in which the error is mitigated, but is not the same.

In the quantum circuit illustrated in FIG. 8, a black circle on the ancillary quantum bit and the rotation operator \hat{ }S on the line of \hat{ }ρᵢ represents a control gate that is applied at the time when the ancillary quantum bit is 1, and a white circle on the ancillary quantum bit and the rotation operator \hat{ }S′ on the line of \hat{ }ρᵢ represents a control gate that is applied at the time when the ancillary quantum bit is 0.

The non-physical state creation unit 330 repeatedly samples \hat{ }S∈S and \hat{ }S′∈S in a uniform distribution at random to compute the expected value of the Pauli X operator of the ancillary quantum bit. This causes the following non-physical state to be virtually output from the quantum circuit.

$$\frac{1}{{\vert 𝕊 \vert}^{2}} {\sum }_{\hat{𝒮} , {\hat{𝒮}}^{′} ∈ 𝕊} \hat{𝒮} {\hat{ρ}}_{i} {\hat{𝒮}}^{′} \qquad [ Math . 16 ]$$

As shown in the above expression (1), the above non-physical state corresponds to “\hat{ }P_{S}\hat{ }ρᵢ\hat{ }P_{S}” obtained by applying the projection operator \hat{ }P_{S} to the quantum state \hat{ }ρᵢ. By expanding \hat{ }P_{S} by the symmetry expansion method using the rotation operator \hat{ }S (the above Expression (2)), the above expression of the non-physical state is obtained. The amount (virtual expected value) is obtained by measuring the Pauli X operator in the quantum circuit in FIG. 8 as described above.

More specifically, a case where the quantum state \hat{ }ρ in which the error is to be mitigated is the logic 0 state is expressed by the following.

$${\hat{𝒫}}_{𝕊} = \frac{1}{2 M} {\sum }_{k = 0}^{2 M - 1} {e}^{i \frac{π}{M} k \hat{N}} \qquad [ Math . 17 ]$$

$$( \hat{𝒮} = {e}^{i \frac{π}{M} k \hat{N}} ( k = 0 , 1 , … , 2 M - 1 ) )$$

A case of the general superposition state of the logic 0 and the logic 1 is expressed by the following.

$${\hat{𝒫}}_{𝕊} = \frac{1}{M} {\sum }_{k = 0}^{M - 1} {e}^{i \frac{2 π}{M} k \hat{N}} \qquad [ Math . 18 ]$$

$$( \hat{𝒮} = {e}^{i \frac{2 π}{M} k \hat{N}} ( k = 0 , 1 , … , M - 1 ) )$$

As the control gate in FIG. 8, a dispersive interaction [5] that is often used in a superconducting quantum circuit can be used. The generalized quantum process proposed in Reference Literature [4] is utilized to create the non-physical state in which separate operators \hat{ }S and \hat{ }S′ are applied from left and right.

### <S104: Quantum Computing>

In S104, the quantum computing unit 340 performs a gate operation (may also be referred to as a quantum algorithm) and then measures the expected value of an observable O, by using a plurality of the following virtual non-physical states obtained by the non-physical state creation unit 330 as an input of the gate operation for the quantum computing.

$$\frac{1}{{\vert 𝕊 \vert}^{2}} {\sum }_{\hat{𝒮} , {\hat{𝒮}}^{′} ∈ 𝕊} \hat{𝒮} {\hat{ρ}}_{i} {\hat{𝒮}}^{′} ( i = 1 , 2 , … , N ) \qquad [ Math . 19 ]$$

At that time, in order to take the projection probability into consideration, <O>/Π^{N}ᵢ₌₁p⁽ⁱ⁾ₛ obtained by normalizing the expected value <O> of the observable O with “Π^{N}ᵢ₌₁p⁽ⁱ⁾ₛ” is adopted as an error-mitigated result. This <O>/Π^{N}ᵢ₌₁p⁽ⁱ⁾ₛ corresponds to \hat{ }ρ_{SE} in Expression (1). In addition, the gate operation (quantum algorithm) corresponds to the U_{C} in the detailed example described later.

### Detailed Example

A detailed example of the content of the processing of performing the error mitigation in the state preparation of the starting state by applying the symmetry expansion method to the rotation-symmetric bosonic code will be described. Hereinafter, the rotation-symmetric bosonic code is referred to as RSBC, and the symmetry expansion method is referred to as SE.

It is assumed that the starting state of a target for which the error is to be mitigated is initialized to, for example, a logic 0 state |0_{M,Φ} [symbol] or a state for gate operation by teleportation. The above-described state for the gate operation includes, for example, a magic state |T_{M,Φ} [symbol] =1/√2 (|0_{M,Φ} [symbol] +e^{iΠ/4}|1_{M,Φ} [symbol] ), a plus state |+_{M,Φ} [symbol] =1/√2(|0_{M,Φ} [symbol] +|1_{M,Φ} [symbol] ), and a plus y state |+i_{M,Φ} [symbol] =1/√2 (|0_{M,Φ} [symbol] +i|1_{M,Φ} [symbol] ).

Before describing the SE formulation for RSBC, an outline of the generalized quantum process introduced in Non-Patent Literature 4 will be described.

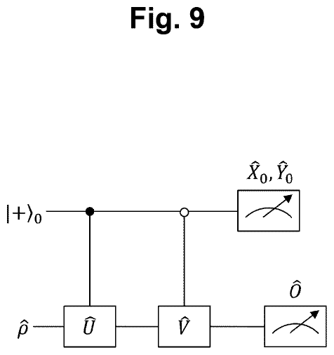

A quantum circuit having unitary operators \hat{ }U and \hat{ }V as illustrated in FIG. 9 is considered. The following equation is obtained by this quantum circuit. The meanings of a black circle and a white circle in FIG. 9 are the same as those in FIG. 8.

$$\text{?} {\hat{X}}_{0} ⊗ \hat{O} \text{?} + i \text{?} {\hat{Y}}_{0} ⊗ \hat{O} \text{?} = Tr [ \hat{O} \hat{U} \hat{ρ} {\hat{V}}^{†} ] \qquad [ Math . 20 ]$$

In the above expression, \hat{ }X₀ and \hat{ }Y₀ are Pauli operators for an ancillary quantum bit, and \hat{ }O is an observable to be measured. This is equivalent to obtaining the following generalized quantum process.

$$Ψ ( \hat{ρ} ) = \hat{U} \hat{ρ} {\hat{V}}^{†} \qquad [ Math . 21 ]$$

In the present embodiment, the SE for RSBC state preparation is executed by using the above-described generalized quantum process. The quantum state preparation unit 310 prepares the noisy logic 0 state as \hat{ }ρᵢ and a resource state for gate rotation as \hat{ }σⱼ. i and j each represent a label of a bosonic quantum bit. The starting state in which the error is mitigated by the SE is expressed by the following expression.

$${\hat{ρ}}_{i}^{S} = \frac{1}{{p}_{i}} {\hat{𝒫}}_{2 M}^{( 0 )} {\hat{ρ}}_{i} {\hat{𝒫}}_{2 M}^{( 0 )} = \frac{1}{{{p}_{i} ( 2 M )}^{2}} {{\sum }^{2 M - 1}}_{{k}_{i} , {k}_{i}^{′} = 0} {\hat{Z}}_{M}^{{k}_{i}} {\hat{ρ}}_{i} {\hat{Z}}_{M}^{{k}_{i}^{′}} , \qquad [ Math . 22 ]$$

$${\hat{σ}}_{j}^{S} = \frac{1}{{q}_{j}} {\hat{𝒫}}_{2 M}^{( c )} {\hat{σ}}_{j} {\hat{𝒫}}_{2 M}^{( c )} = \frac{1}{{q}_{j} {M}^{2}} {{\sum }^{M - 1}}_{{l}_{j} {l}_{j}^{′} = 0} {\hat{R}}_{M}^{{l}_{j}} {\hat{σ}}_{j} {\hat{R}}_{M}^{{l}_{j}^{′}}$$

In the above expression, each of the following is projection probability.

$${p}_{i} = Tr [ {\hat{𝒫}}_{2 M}^{( 0 )} {\hat{ρ}}_{i} ] , \qquad [ Math . 23 ]$$

$${q}_{j} = Tr [ {\hat{𝒫}}_{2 M}^{( c )} {\hat{σ}}_{j} ]$$

Here, the observable and the process to be measured in the quantum circuit including teleportation and an error correction procedure are represented by O and U_{C}, respectively. The quantum circuit includes a rounding process for classical error correction of measurement of the observable in the U_{C}. The expected value of the observable whose error is mitigated is expressed by the following expression.

$$\begin{matrix}〈 {\hat{O}}_{SE} 〉 = Tr [ {OU}_{C} ( ( {⊗}_{i = 0}^{{N}_{\hat{ρ}} - 1} {\hat{ρ}}_{i}^{S} ) ⊗ ( {⊗}_{j = 0}^{{N}_{\hat{σ}} - 1} {\hat{σ}}_{j}^{S} ) ) ] \\ = \frac{1}{( {\prod }_{i} {p}_{i} {\prod }_{j} {q}_{j} ) {( 2 M )}^{2 {N}_{\hat{ρ}}} {M}^{2 {N}_{\hat{σ}}}}\end{matrix} \times {\sum }_{\vec{l} , {\vec{l}}^{′} , \vec{k} , {\vec{k}}^{′}} Tr [ \hat{O} {U}_{C} ( ( {⊗}_{i = 0}^{{N}_{\hat{ρ}} - 1} {\hat{Z}}_{M}^{{k}_{i}} {\hat{ρ}}_{i} {\hat{Z}}_{M}^{{k}_{i}^{′}} ) ⊗ ( {⊗}_{j = 0}^{{N}_{\hat{σ}} - 1} {\hat{R}}_{M}^{{l}_{j}} {\hat{σ}}_{j} {\hat{R}}_{M}^{{l}_{j}^{′}} ) ) ] \qquad [ Math . 24 ]$$

In the above expression, it is defined as follows.

$$\vec{k} = ( {k}_{0} , {k}_{1} , … , {k}_{{N}_{\hat{ρ}} - 1} ) , \qquad [ Math . 25 ]$$

$${\vec{k}}^{′} = ( {k}_{0}^{′} , {k}_{1}^{′} , … , {k}_{{N}_{\hat{ρ}} - 1}^{′} ) ,$$

$$\vec{l} = ( {l}_{0} , {l}_{1} , … , {l}_{{N}_{\hat{σ}} - 1} ) ,$$

$$\vec{{l}^{′}} = ( {l}_{0}^{′} , {l}_{1}^{′} , … , {l}_{{N}_{\hat{σ}} - 1}^{′} )$$

In addition, N_{\hat{ }ρ} (N_{\hat{ }σ}) represents the number of bosonic quantum bits for \hat{ }ρᵢ (\hat{ }σᵢ).

In order to calculate the expression of “Math. 24”, first, the projection probability calculation unit 320 computes the projection probabilities pᵢ and qⱼ. As described above, these projection probabilities may be computed by classical simulation by giving a noise model, or may be directly evaluated by using a linear combination of expected values of \hat{ }Z^{k}_{M} or \hat{ }R^{k}_{M} measured using the Hadamard test circuit.

In order to calculate an unbiased estimator for the other part in “Math. 24”, that is, for “Math. 26” below, first, the non-physical state creation unit 330 randomly generates, with a uniform distribution, the following expressed by “Math. 27”.

$$( {\prod }_{i} {p}_{i} {\prod }_{j} {q}_{j} ) \text{?} {\hat{O}}_{SE} \text{?} \qquad [ Math . 26 ]$$

$$( \vec{k} , {\vec{k}}^{′} , \vec{l} , {\vec{l}}^{′} ) \qquad [ Math . 27 ]$$

Then, the non-physical state creation unit 330 executes, by using the generalized quantum process, the following non-physical operations.

$${\{ {\hat{Z}}_{M}^{{k}_{i}} ( \cdot ) {\hat{Z}}_{M}^{{k}_{i}^{′}} \}}_{i} \qquad [ Math . 28 ]$$

$${\{ {\hat{R}}_{M}^{{l}_{j}} ( \cdot ) {\hat{R}}_{M}^{{l}_{j}^{′}} \}}_{j} \qquad [ Math . 29 ]$$

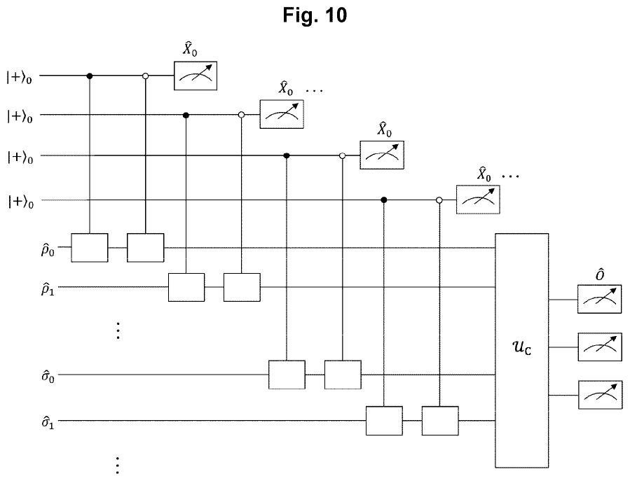

Here, a quantum circuit using one ancillary quantum bit for each bosonic quantum bit as illustrated in FIG. 10 is used. A blank square in FIG. 10 represents a rotation operator. In each SE procedure, the ancillary quantum bit can be reused. Subsequently, the quantum computing unit 340 executes the process (quantum algorithm) corresponding to the U_{C} and finally measures the observable \hat{ }O.

The quantum computing device 300 repeatedly executes this procedure to compute the unbiased estimator of the following.

$$( {\prod }_{i} {p}_{i} {\prod }_{j} {q}_{j} ) \text{?} {\hat{O}}_{SE} \text{?} \qquad [ Math . 30 ]$$

Here, because “(\hat{ }O_{SE}), pᵢ, qⱼ∈R”, there is no contribution from the imaginary part of the expression of “Math. 20”. Therefore, it is not necessary to measure the Pauli Y operator of the ancillary quantum bit. More specifically, assuming that the unbiased estimator of (\hat{ }O_{SE}) obtained by this procedure is μ_{SE}, the following is obtained.

$$\text{?} {μ}_{SE} \text{?} = \frac{1}{( {\prod }_{i} {p}_{i} {\prod }_{j} {q}_{j} )} \text{?} {\vec{X}}_{0} ⊗ \hat{O} \text{?} \qquad [ Math . 31 ]$$

Here, −X₀ is a product of the Pauli X operator of the ancillary quantum bit.

### (Hardware Configuration Example of Control Device 100)

The control device 100 described in the present embodiment can be realized by causing a computer to execute a program. This computer may be a physical computer or may be a virtual machine on a cloud.

That is, the control device 100 can be implemented by executing a program corresponding to the processing executed in the control device 100 by using hardware resources such as a CPU or a memory installed in the computer. The above program can be stored and distributed by being recorded in a computer-readable recording medium (such as a portable memory). Furthermore, the above program can also be provided through a network such as the Internet or an electronic mail.

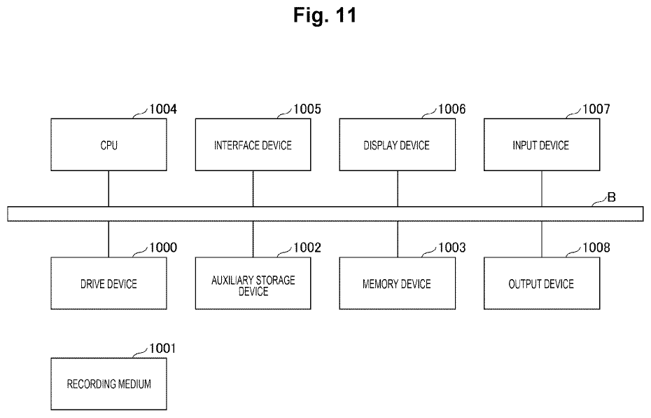

FIG. 11 is a diagram illustrating a hardware configuration example of the computer. The computer in FIG. 11 includes a drive device 1000, an auxiliary storage device 1002, a memory device 1003, a CPU 1004, an interface device 1005, a display device 1006, an input device 1007, an output device 1008, and the like, which are connected to each other by a bus BS. Note that the computer may further include a GPU.

The program for implementing the processing in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to activate the program is given, the memory device 1003 reads the program from the auxiliary storage device 1002 and stores the program. The CPU 1004 implements a function related to the control device 100 in accordance with the program stored in the memory device 1003. The interface device 1005 is used as an interface for connecting to a network or the quantum processor 200. The display device 1006 displays a graphical user interface (GUI) or the like according to the program. The input device 1007 includes a keyboard and a mouse, a button, a touchscreen, or the like and is used to input various operation instructions. The output device 1008 outputs an operation result.

### Effects of Embodiment

As described above, the technology described in the present embodiment makes it possible to suppress the state preparation error in the starting state in the quantum computing.

With regard to the above embodiment, the following clauses are further disclosed.

### CLAUSES

### (Clause 1)

A quantum computing device including:
a state creation unit that creates a non-physical state corresponding to a quantum state in which a projection operator to a code space of a rotation-symmetric bosonic code is applied to a quantum state in which an error has occurred during state preparation; and
a quantum computing unit that executes a quantum algorithm using the non-physical state as an input and computes an expected value of an observable.

### (Clause 2)

The quantum computing device according to Clause 1, in which
the state creation unit creates the non-physical state by using a rotation operator by a symmetry expansion method.

### (Clause 3)

The quantum computing device according to Clause 2, in which
the state creation unit creates the non-physical state by using a quantum circuit including a control gate that causes a rotation operator to be applied when an ancillary quantum bit is 1 and a control gate that causes another rotation operator to be applied when the ancillary quantum bit is 0.

### (Clause 4)

The quantum computing device according to any one of Clauses 1 to 3, further including
a projection probability calculation unit that calculates a projection probability of the projection operator, in which
the quantum computing unit normalizes the expected value by the projection probability.

### (Clause 5)

The quantum computing device according to Clause 4, in which
the projection probability calculation unit calculates the projection probability by simulation using a noise model for state preparation, or calculates the projection probability by using a Hadamard test circuit.

### (Clause 6)

A quantum computing method executed by a quantum computing device, the method including:
a step of creating a non-physical state corresponding to a quantum state in which a projection operator to a code space of a rotation-symmetric bosonic code is applied to a quantum state in which an error has occurred during state preparation; and
a step of executing a quantum algorithm using the non-physical state as an input and computing an expected value of an observable.

### (Clause 7)

A non-transitory storage medium storing a program configured to cause a computer to function as each unit in the quantum computing device according to any one of Clauses 1 to 5.

Although the present embodiment has been described above, the present invention is not limited to such a specific embodiment, and various modifications and changes can be made within the scope of the gist of the present invention described in the claims.

### REFERENCE LITERATURE

[1] McClean, Jarrod R., Zhang Jiang, Nicholas C. Rubin, Ryan Babbush, and Hartmut Neven. “Decoding quantum errors with subspace expansions.” Nature communications 11, no. 1 (2020): 1-9.
[2] Cai, Zhenyu. “Quantum error mitigation using symmetry expansion.” Quantum 5 (2021): 548.
[3] Grimsmo, Arne L., Joshua Combes, and Ben Q. Baragiola. “Quantum computing with rotation-symmetric bosonic codes.” Physical Review X 10, no. 1 (2020): 011058.
[4] Sun, Jinzhao, Suguru Endo, Huiping Lin, Patrick Hayden, Vlatko Vedral, and Xiao Yuan. “Perturbative quantum simulation.” Physical Review Letters 129, no. 12 (2022): 120505.
[5] Ma, Wen-Long, Shruti Puri, Robert J. Schoelkopf, Michel H. Devoret, Steven M. Girvin, and Liang Jiang. “Quantum control of bosonic modes with superconducting circuits.” Science Bulletin 66, no. 17 (2021): 1789-1805.

Reference Signs List

| | |
|---|---|
| 100 | Control device |
| 200 | Quantum processor |
| 300 | Quantum computing device |
| 310 | Quantum state preparation unit |
| 320 | Projection probability calculation unit |
| 330 | Non-physical state creation unit |
| 340 | Quantum computing unit |
| 1000 | Drive device |
| 1001 | Recording medium |
| 1002 | Auxiliary storage device |
| 1003 | Memory device |
| 1004 | CPU |
| 1005 | Interface device |
| 1006 | Display device |
| 1007 | Input device |
| 1008 | Output device |

1. A quantum computing apparatus comprising:
circuitry configured to:
create a non-physical state corresponding to a first quantum state in which a projection operator on a code space of a rotation-symmetric bosonic code is applied to a second quantum state in which an error has occurred during state preparation;
execute a quantum algorithm using the non-physical state as an input; and
compute an expected value of an observable based on the execution of the quantum algorithm.

2. The quantum computing apparatus according to claim 1, wherein the circuitry is configured to create the non-physical state by using a rotation operator group by a symmetry expansion method.

3. The quantum computing apparatus according to claim 2, wherein the circuitry is configured to create the non-physical state by using a quantum circuit including:
a first control gate configured to apply a first rotation operator when an ancillary quantum bit is 1, and
a second control gate configured to apply a second rotation operator when the ancillary quantum bit is 0.

4. The quantum computing apparatus according to claim 1, wherein the circuitry is configured to:
calculate a projection probability of the projection operator, and
normalize the expected value based on the projection probability.

5. The quantum computing apparatus according to claim 4, wherein the circuitry is configured to:
calculate the projection probability by a simulation that uses a noise model for the state preparation, or
calculate the projection probability by using a Hadamard test circuit.

6. A quantum computing method executed by a quantum computing apparatus, the quantum computing method comprising:
creating a non-physical state corresponding to a first quantum state in which a projection operator on a code space of a rotation-symmetric bosonic code is applied to a second quantum state in which an error has occurred during state preparation;
executing a quantum algorithm using the non-physical state as an input; and
computing an expected value of an observable based on the execution of the quantum algorithm.

7. A non-transitory computer readable storage medium storing a program configured to cause a computer to execute the quantum computing method of claim 6.
